(19) United States
(12) Patent Application Publication
(10) Pub. No.: US 2005/0213316 A1
(43) Pub. Date: Sep. 29, 2005

(54) Illuminated post system

(76) Inventors: Tony Inman, Lansing, IL (US); Jacob Majszak, Lynwood, IL (US)

Correspondence Address: RICHARD C. HIMELHOCH, 311 S. WACKER DRIVE, 53RD FLOOR, CHICAGO, IL, 60606-6622, US

(21) Appl. No.: 10/806,932

(22) Filed: Mar. 23, 2004

(51) Int. Cl. F21S 8/00

(52) U.S. Cl. 362/152; 362/414; 362/431

(57) ABSTRACT

An illuminated post system comprising a plurality of fence posts connected by slats to form at least a portion of a fence. Each of the plurality of fence posts including a lighted base member secured to a top portion of the fence posts. Each lighted base member including at least a first recessed portion having a first aperture and an internal light source. The first recessed portion preferably is a generally curvilinear concave shape. Additional apertures can be provided on the lighted base members. The apertures can be various sizes, shapes or designs and may include clear or translucent covers of various colors. Light emitting through the aperture in the recessed portion provides an indirect lighting or glowing effect.

### TECHNICAL FIELD

The present invention is generally related to a lighted base having a generally concave mid-portion for use with a fencing system, and more particularly, to a fence having a plurality of fence posts positioned about the fence with lighted bases having generally concave mid-portions with internal light sources.

### BACKGROUND OF THE INVENTION

Outdoor lighting systems have typically been limited to lights attached to a home or building structure, or placed in solitary lamp posts. Other structures around the home or building were left in darkness.

A lighting system placed in a structure can enhance its visual appearance (especially at night) and add to the decorative, stylistic nature of the structure. The lighting system can also provide additional illumination to an area surrounding the structure.

One area where lighting systems have rarely been used is with fence structures, and more particularly with the posts of the fence structures. Such structures come in a multitude of styles and configurations in order to enhance or conform with the architectural style around or near the fence. Combining a lighting system with such structures can result in unique structures that are both aesthetically appealing and functional. The present invention is directed toward certain unique aspects of such a combination.

### SUMMARY OF THE INVENTION

The present invention provides a lighting element in the form of a universal lighted base for illuminating posts of a fencing system. The fencing system includes a plurality of fence posts connected by slats, beams or other conventional fence structure. Preferably, each fence post in the system includes a lighting element in accordance with the invention. The lighting element is preferably configured to have recessed or concave portions wherein a light emitting aperture can be positioned. Light is then preferably reflected from the surface of the recessed or concave portion. The indirect lighting achieved in the present invention provides an ethereal glowing effect to the lighting element.

In one embodiment of the invention, an illuminated post system comprises at least a first fence post connected to a fence. A first base member is secured to a top end of the first fence post of the fence. The first base member includes a first aperture and a first light source disposed in the first base member. The first base member has an outer configuration that includes at least a first recessed portion. The first aperture is positioned in the first recessed portion. The light source provides light which is emitted through the first aperture. The light is then reflected from the surface of the recessed portion to provide a glowing effect. The first base member can include a second aperture or a plurality of additional apertures.

A first ornamental cap can be secured to the first base member, preferably on the top of the first base member. The first ornamental cap can be formed from an opaque material, or alternatively can be formed from a clear or translucent material allowing light from the light source to emit through the ornamental cap.

In addition to the first base member, the illuminated post system preferably includes a second base member secured to a top portion of a second fence post connected to the fence. Similar to the first base member, the second base member also includes a recessed portion having a first aperture and a light source (i.e., a second light source) disposed in the second base member. In fact, preferably the fencing system includes a plurality of fence posts wherein each fence post includes a base member having at least a recessed portion having a first aperture and an internal light source.

The base member may include a plastic insert or lens covering the first aperture. The lens can be a clear material or a translucent material having some color.

The first fence post, as well as the second or subsequent fence posts, can be formed to have a hollow interior portion. Additionally, the fence posts can be connected by slats having a hollow interior portion. In this set up, wires or a wiring system from a power source can be strung within the interior portion of the first post, the second post and the slats to provide electrical power for the first light source, the second light source, and any subsequent light sources in the system. Alternative power sources, such as batteries can also be utilized in the system.

The first base member can be configured to comprise a generally hollow frame. The first light source (preferably a light bulb or other conventional light source) can be mounted in an interior portion of the first base member. The frame can be formed to have a first side, a second side, a third side and a fourth side; however, a variety of shapes or designs can be used. For example, the recessed portion in the first base member can be a generally semi-circular (in cross-section) concave first surface having the first aperture placed in an upper portion of the first surface.

In another embodiment of the invention, an illuminated post system comprises a plurality of fence posts connected by slats to form at least a portion of a fence. Each of the plurality of fence posts in the system includes a lighted base member secured to a top portion of the fence posts. Moreover, each lighted base member includes at least a first recessed portion containing at least a first aperture and an internal light source.

The lighted base members may include a second aperture or further additional apertures as desired. Moreover, each lighted base member may include a different number of apertures, and/or apertures of different sizes and shapes. Similarly, each lighted base member may comprise an ornamental cap of same or different configurations.

The light source in each of the lighted base members can comprise a light bulb positioned within an interior portion of the lighted base member. The light bulb is preferably connected to a base plate connected to the illuminate base member. A wiring system is provided for providing electrical energy to the light source in each base member. At least a portion of the slats in the system include a hollow interior portion to accommodate the wiring system.

In yet another embodiment of the invention, a fence post illumination system comprises a lighted base member configured for placement on a top portion of a fence post of a fence, the lighted base member comprises a bottom portion shaped to engage the top portion of the fence post, and a sidewall portion extending upward from the bottom portion wherein the sidewall portion includes at least a first aperture and the lighted base member further comprises an internal light source.

The sidewall portion can include a generally concave portion, and the first aperture can be positioned in an upper portion of the concave portion to provide for enhanced reflective lighting properties. That is, light from the aperture will advantageously reflect off the concave walls of the concave portion to provide a glowing appearance.

The lighted base member can include a generally hollow interior portion. Moreover the system can comprise a base plate connected to the bottom portion of the lighted base member to support the internal light source connected to the base plate in the interior portion of the lighted base member.

The shape of the bottom portion of the lighted base member can be generally rectangular. The sidewall portion can include a first sidewall segment extending from a first wall of the rectangular bottom portion, a second sidewall segment extending from a second wall of the rectangular bottom portion, a third sidewall segment extending from a third wall of the rectangular bottom portion, and a fourth sidewall segment extending from a fourth wall of the rectangular bottom portion. The first aperture can be positioned in the first sidewall segment. Additionally, a second aperture can be positioned in the second sidewall segment, a third aperture position in the third sidewall segment, and a fourth aperture positioned in the fourth side wall segment. Further, the first sidewall segment can include a recessed portion in the form of a generally concave portion. Similarly, the second sidewall segment can include a recessed portion in the form of a generally concave portion, the third sidewall segment can include a recessed portion in the form of a generally concave portion, and the fourth sidewall segment can include a recessed portion in the form of a generally concave system. However, numerous modifications can be made to the shape and size of the lighted base member without departing from the invention.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of a base member for use with the present invention having four apertures.

FIG. 2 is a perspective view of a base member for use with the present invention having two apertures;

FIG. 3 is a cross-sectional view of the base member of FIG. 1;

FIG. 4 is a perspective view of a base member with one embodiment of an ornamental cap connected to the base member;

FIG. 5 is a perspective view of a base member with another embodiment of an ornamental cap connected to the base member;

FIG. 6 is a perspective view of a lens for covering an aperture in a base member;

FIG. 7 is a perspective view of a bottom plate for use with a base member;

FIG. 8 is a plan view of one end of the lens of FIG. 6;

FIG. 9 is a partial cross-sectional view of an end of the lens of FIG. 6; and,

FIG. 10 is a partial cross-sectional view of a lighted fencing system in accordance with the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

The present invention is an illuminated post system having lighting elements on fence posts of a fence wherein each lighting element includes recessed portions having apertures for emitting light from an internal light source. Preferably, the fence is a type having a plurality of fence posts connected by one or more slats extending from fence post to fence post. The slats extending between the fence posts may form the entire fence, or vertically positioned boards can be connected to the slats. The slats can extend generally horizontally, or at an angle (for example, two slats can form an “X” between two posts wherein the first slat starts from the bottom of a first post to the top of a second post and the second slat starts from the top of the first post and extends to the bottom of the second post). However, a large variety of fence structures can be utilized with the present invention. In accordance with the invention, the lighting elements are placed at the tops of one or more of the fence posts.

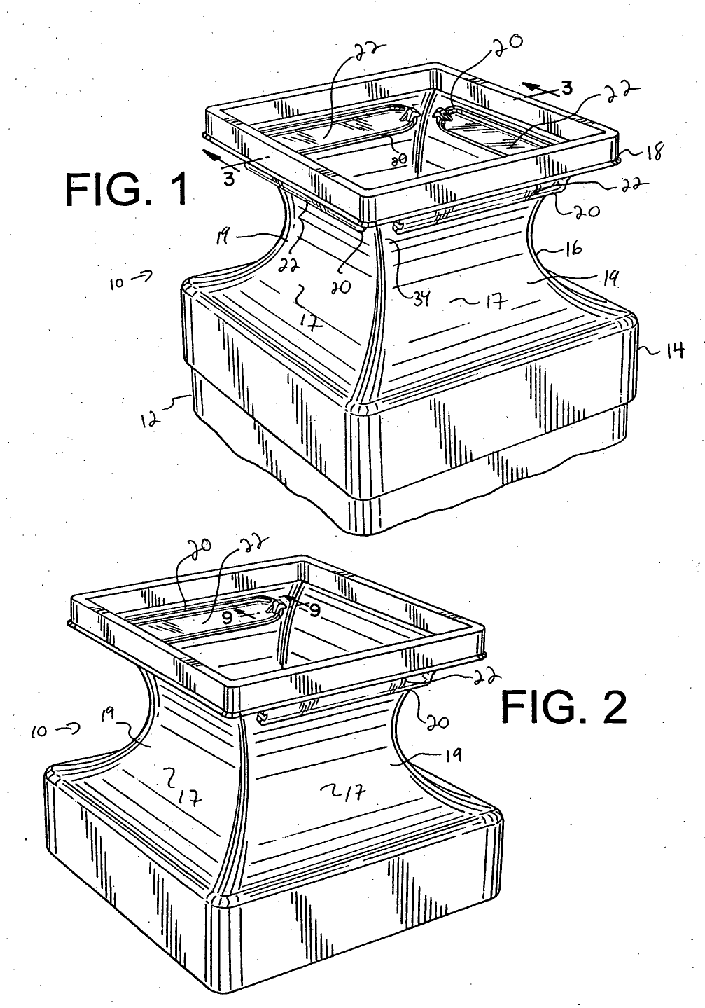

Referring to FIG. 1, a lighting element in the form of a lighted base member 10 is shown positioned on the top of a fence post 12. The lighted base member 10 shown in FIG. 1 includes a bottom portion 14 having a generally rectangular shape. In this case, the bottom portion 14 is square; however, other shapes such as circular, octagonal, oval etc., can be used. Preferably, the bottom portion 14 of the lighted base member 10 is configured to match the cross-sectional shape of the fence post 12.

The lighted base member 10 further includes a sidewall portion 16 extending upward from the base portion 14, to a top portion 18. The sidewall portion 16 in the embodiment shown in FIG. 1 includes four sides or sidewall segments 17 (two of which are shown in the perspective views of FIGS. 1 and 2) that generally correspond to the four sides of the rectangular shaped base portion 14. The side wall portion 16 can include more or less sides, or be more rounded to reflect different configurations of the base portion 14. In fact, the sidewall portion, as well as the remainder of the base member, can be configured in numerous ornamental configurations without departing from the spirit of the present invention.

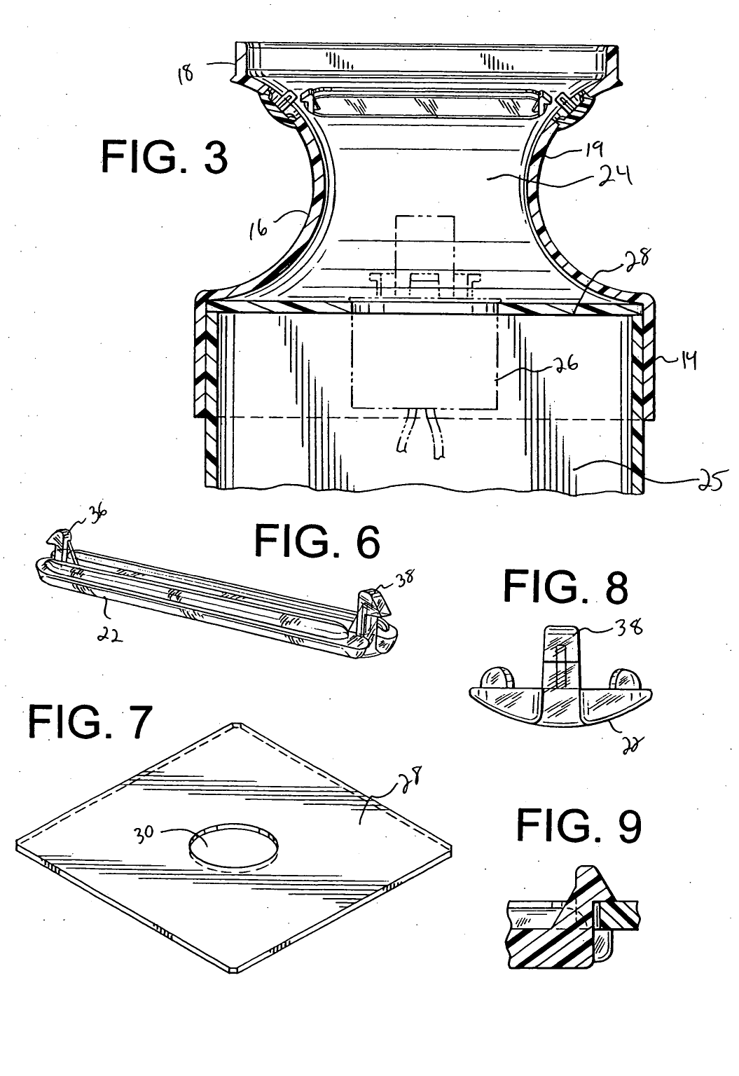

In the preferred embodiment shown in the Figures and as particularly shown in FIG. 3, the base portion 14 is securely fitted over a top end of the fence post 12. A screw, nail, glue or other similar means can be utilized to more permanently secure the lighted base member 10 to the post 12. However, the securing means used should allow for easy replacement of light bulbs.

The lighted base member 10 includes four apertures 20, each of the apertures is positioned in a recessed portion 19 in a respective one of the sidewall segments. The four concave sidewall segments form a first recessed portion 19, a second recessed portion 19, a third recessed portion 19 and a fourth recessed portion 19, respetively. Each aperture 20 includes a cover or lens element 22 secured to the lighted base member 10 in the aperture 20. In an alternative embodiment, FIG. 2 shows a lighted base member 10 having two apertures on opposing sidewall segments. It will be understood that the number, placement and shape of the apertures can be modified without departing from the spirit of the present invention.

As shown in cross-section in FIG. 3, the lighted base member 10 includes a generally hollow interior portion 24. The fence post 12 also includes a hollow interior portion 25. A light source 26 is positioned in the interior portion 24 of the lighted base member 10. When activated, the light source 26 provides light which shines through the apertures 20 in the lighted base member 10, thus creating a lighting element on the fence post 12. The light source 26 in the embodiment shown in FIG. 3, is connected to a base plate 28 associated with the lighted base member 10, which positions the light source 26 roughly in the middle of the lighted base member 10. As more fully shown in FIG. 7, the base plate 28 includes a hole 30 in the center of the plate 28 through which the light source 26 (e.g., a light bulb socket) can be secured and positioned. The base plate 28 spans the top portion of the fence post 12 and fits into the interior of the bottom portion 14 of the lighted base member 10. The base plate 28 can be secured to the fence post 12 or the lighted base member 10, or can be loosely placed between the two and held in place by the lighted base member 10.

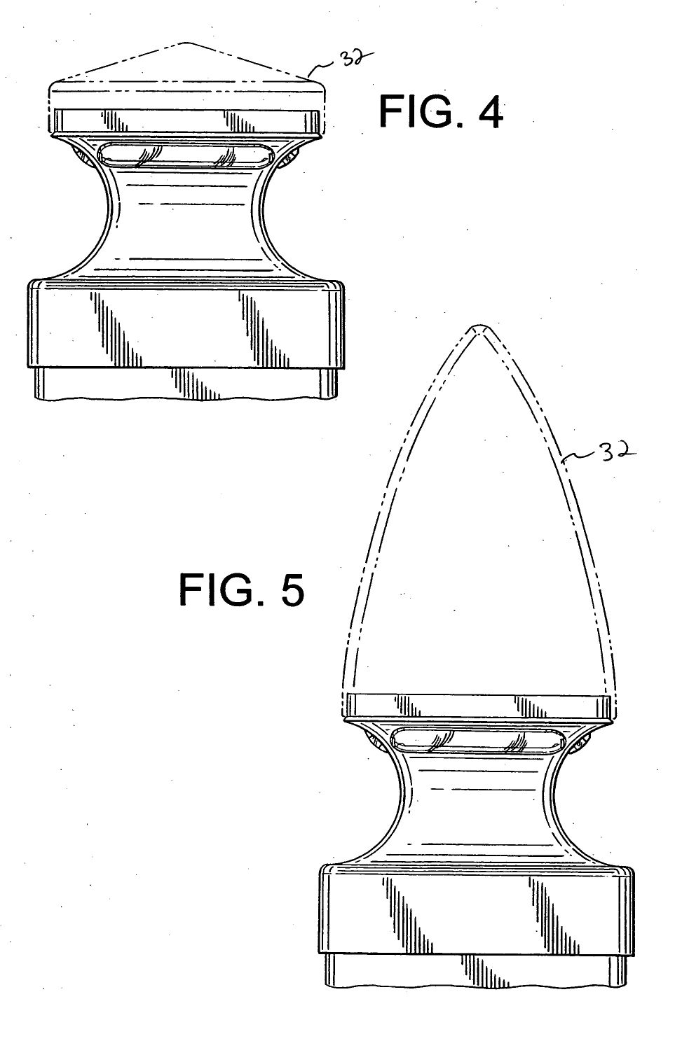

FIG. 4 shows the lighted base member 10 with one embodiment of an ornamental cap 32 (shown in phantom) secured to the top portion 18 of the lighted base member 10. Another embodiment of an ornamental cap 32 is shown in FIG. 5 (also shown in phantom). Numerous modifications can be made to the shape of the ornamental cap in accordance with the design of the fence or other architectural features near the fence. The ornamental cap 32 can be formed from an opaque material. Alternatively, the ornamental cap 32 can be formed from a clear or translucent material (e.g., a plastic material) to allow light from the light source 26 to emit through the cap 32, or can include additional apertures similar to those in the base member 10.

The preferred apertures 20 are shown as horizontal slots positioned along the upper portion 34 of each sidewall segment 17. The apertures 20 can be configured in a number of different shapes, sizes and positions as desired. In the embodiment shown in FIGS. 1 and 2, the recessed portions of the side wall segments 17 have a generally concave shape (also shown in FIG. 3). Placement of the apertures 20 in the upper portion 34 of the sidewall segments 17, causes light from the aperture 20 to reflect from the remaining portion of the sidewall segment 34, providing a unique, glowing effect.

The lens element 22 is shown more fully in FIGS. 6, 8 and 9. The lens element 22 is designed to fit into and cover the aperture 20. The lens element is provided with a first flange 36 and a second flange 38 to snap fittingly be secured to the lighted base member 10. The lens element can be a clear plastic, or can be a translucent plastic having some color. The aperture 20 and the corresponding lens element 22 can be configured in numerous shapes and sizes, forming patterns, designs or words.

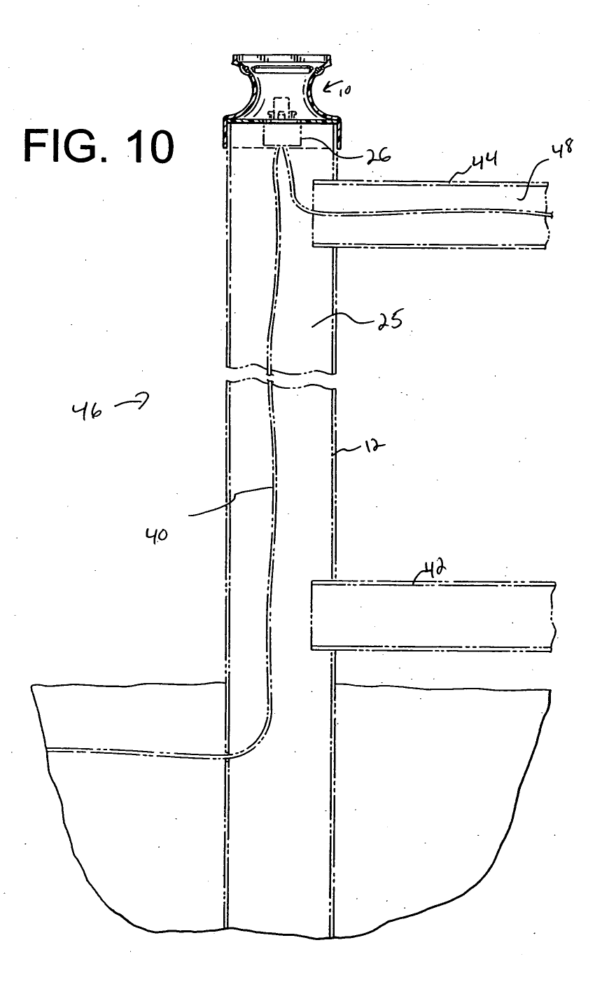

Referring to FIG. 10, a cross-sectional view of a fence post 12 connected to a first slat 42 and a second slat 44 in an illuminated post system 46 is shown. The first and second slats 42 and 44 extend to the next fence post (not shown) which is preferably of the same design as the first fence post. Additional slats can then proceed to subsequent fence posts in a like manner until the fence is completed. A large variety of fence structures can be utilized between the fence posts depending on the desired design of the fence.

A light source 26 is shown positioned at the top of the fence post 12 in FIG. 10. The light source 26 can be a socket and light bulb or other conventional lighting elements. The light source 26 in FIG. 10 is connected to a standard A/C power source (not shown) through a wire 40. The wire 40 is preferably positioned underground until it reaches the first fence post 12 of the post system 46 and is then run through the hollow interior 25 of the fence post 12. At least one of the slats (e.g., 44) connecting the first fence post 12 to the next fence post 12 is also provided with a hollow interior 48 to allow the wire to extend to the next fence post 12 and lighted base member 10. Additional hollow fence posts 12 and slats 44 can be provided to complete the fencing system 46 and hide the wiring.

A conventional switch can be utilized to turn the light sources on or off. However, more sophisticated systems can be utilized to turn various light sources 26 in the system on and off as desired, or to allow the light source to be dimmed or brightened. Such systems may also provide a strobe or Christmas tree light effect.

In alternative forms of the invention, the light sources 26 can be provided with batteries (e.g., conventional batteries, solar powered batteries etc) or other alternative power sources. In such embodiments, the wire 40 and hollow interiors of the fence posts 12 and slats 44 would not be necessary.

In another alternative form of the invention, the wire 40 may be run underground from fence post 12 to fence post 12, or through a small tube run along the fence, rather than through slats connecting the fence posts.

While the preferred fencing systems are the traditional fence structures, the illuminated system of the present invention can include other fence-like structures. For example, railing for a deck or balcony, or along an outdoor stairway or walkway can incorporate the lighted base members to light such structures.

It should be emphasized that the above-described embodiments of the present invention, particularly, any “preferred” embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. An illuminated post system comprising:
a first fence post connected to a fence;
a first base member secured to a top end of the first fence post of the fence, the first base member including a first recessed portion and a first aperture disposed in the first recessed portion; and,
a first light source disposed in the first base member, the first light source providing light to be emitted through the first aperture.

2. The illuminated post system of claim 1 further comprising:
a first ornamental cap secured to the first base member.

3. The illuminated post fencing system of claim 1 further comprising:
a second base member secured to a top portion of a second fence post connected to the fence, the second base member including a first recessed portion and a first aperture disposed in the first recessed portion; and,
a second light source disposed in the second base member.

4. The illuminated post system of claim 1 wherein the base member further includes a second aperture.

5. The illuminated post system of claim 1 further comprising a lens covering the first aperture.

6. The illuminated post system of claim 3 wherein the first fence post and the second fence post are connected by a first slat, and wherein wiring is strung within an interior portion of the first post, the second post and the first slat to provide electrical power for the first light source and the second light source.

7. The illuminated post system of claim 1 wherein the first base member comprises a generally hollow frame having a first side, a second side, a third side and a fourth side, and wherein the first light source is mounted in an interior portion of the first base member.

8. The illuminated post system of claim 1 wherein the first recessed portion forms a generally concave first surface, and wherein the first aperture is placed in an upper portion of the first surface.

9. The illuminated post system of claim 1 wherein the first light source is a light bulb disposed within the first base member.

10. The illuminated post system of claim 5 wherein the lens is a translucent material.

11. The illuminated post system of claim 2 wherein the first ornamental cap comprises a translucent material.

12. An illuminated post system comprising:
a plurality of fence posts connected by slats to form at least a portion of a fence;
each of the plurality of fence posts including a lighted base member secured to a top portion of the fence posts; and,
each lighted base member including a first recessed portion containing a first aperture, and an internal light source.

13. The illuminated post system of claim 12 wherein at least one lighted base member further includes a second recessed portion containing a second aperture.

14. The illuminated post system of claim 12 wherein each lighted base member includes a second recessed portion containing a second aperture.

15. The illuminated post system of claim 12 further comprising a plurality of ornamental caps, each cap connected to a base member secured to the plurality of fence posts.

16. The illuminated post system of claim 12 wherein the first aperture in each lighted base member includes a first lens element secured to the first aperture.

17. The illuminated post system of claim 16 wherein the first lense element is a clear material.

18. The illuminated post system of claim 16 wherein the first lense element is a translucent material having a color.

19. The illuminated post system of claim 12 wherein the light source comprises a light bulb positioned within an interior portion of the lighted base member.

20. The illuminated post system of claim 19 wherein the light bulb is connected to a base plate which is connected to the base member.

21. The illuminated post system of claim 12 further comprising a wiring system for providing electrical energy to the light source in each base member.

22. The illuminated post system of claim 21 wherein at least a portion of the slats each include a hollow interior portion to accommodate the wiring system.

23. A fence post illumination system comprising:
a lighted base member configured for placement on a top portion of a fence post of a fence, the lighted base member comprising a bottom portion shaped to engage the top portion of the fence post, a sidewall portion extending upward from the bottom portion, the sidewall portion including a first recessed portion having a first aperture, the lighted base member further including an internal light source.

24. The fence post illumination system of claim 23 wherein the lighted base member includes a generally hollow interior portion.

25. The fence post illumination system of claim 23 further comprising an ornamental cap connected to a top portion of the lighted base member.

26. The fence post illumination system of claim 23 further comprising a second recessed portion having a second aperture in the sidewall portion of the lighted base member.

27. The fence post illumination system of claim 23 further comprising a plurality of additional apertures in the sidewall portion of the lighted base member.

28. The fence post illumination system of claim 23 further comprising a lens element secured to the lighted base member in the first aperture.

29. The fence post illumination system of claim 25 wherein the ornamental cap comprises a translucent material.

30. The fence post illumination system of claim 23 wherein the first recessed portion in the sidewall portion includes a generally concave portion.

31. The fence post illumination system of claim 30 wherein the first aperture is positioned in an upper portion of the concave portion.

32. The fence post illumination system of claim 23 further comprising a base plate connected to the bottom portion of the lighted base member, the internal light source connected to the base plate.

33. The fence post illumination system of claim 23 wherein the shape of the bottom portion of the lighted base member is generally rectangular, and the sidewall portion includes a first sidewall segment extending from a first wall of the rectangular bottom portion, a second sidewall segment extending from a second wall of the rectangular bottom portion, a third sidewall segment extending from a third wall of the rectangular bottom portion, and a fourth sidewall segment extending from a fourth wall of the rectangular bottom portion, the first aperture positioned in the first sidewall segment.

34. The fence post illumination system of claim 33 further comprising a second aperture positioned in the second sidewall segment, a third aperture position in the third sidewall segment, and a fourth aperture positioned in the fourth side wall segment.

35. The fence post illumination system of claim 33 wherein the first sidewall segment includes a generally concave portion, the second sidewall segment includes a generally concave portion, the third sidewall segment includes a generally concave portion, and the fourth sidewall segment includes a generally concave system.
